(19) United States
(12) Patent Application Publication
(10) Pub. No.: US 2026/0155466 A1
(43) Pub. Date: Jun. 4, 2026

(54) BATTERY PACK WITH DETACHABLE ELECTRONICS MODULE

(71) Applicant: Porsche eBike Performance GmbH, Ottobrunn (DE)

(72) Inventors: Anton Kanyshev, Zagreb (HR); Morovic Dinko, Zagreb (HR); Stjepko Peleh, Zagreb (HR)

(21) Appl. No.: 19/408,729

(22) Filed: Dec. 4, 2025

(30) Foreign Application Priority Data
Dec. 4, 2024 (DE) 102024136148.4

(51) Int. Cl. H01M 10/42; H01M 10/04; H01M 50/284

(52) U.S. Cl. CPC H01M 10/4257; H01M 10/04; H01M 50/284; H01M 2220/20

(57) ABSTRACT

In an embodiment a battery pack includes a battery module having a plurality of battery cells, which are electrically connected to one another, and an electronics module, wherein the electronics module and the battery module are detachably connected to each other.

### CROSS-REFERENCE TO RELATED APPLICATIONS

This application claims priority to German Application No. 10 2024 136 148.4, filed on Dec. 4, 2024, which application is hereby incorporated herein by reference.

### TECHNICAL FIELD

The invention relates to a battery pack. The battery pack may be used to supply power to a drive unit of a bicycle. The invention also relates to a bicycle with such a battery pack and to a method for assembling such a battery pack.

### BACKGROUND

Battery packs for supplying power to a drive unit of a bicycle are well known in the prior art. Such bicycles with a drive unit and a battery pack are also referred to as e-bikes or pedelecs. The drive unit is in particular an electric motor which is connected to the battery pack for power transmission. A battery pack usually comprises a housing in which one or more battery cells are arranged. Several battery cells are usually combined to form a battery module and interconnected within the battery module.

In addition, battery packs usually comprise a so-called electronics module with electronics and a battery management system (BMS). Among other things, the BMS is used to monitor the voltage and temperature of the battery cells, as well as to control the load and charging of the battery cells and to balance the battery cells. Furthermore, the electronics module usually has a (main) connection plug for charging and discharging the battery pack.

The electronics module is usually welded to the battery module and/or connected via cables. If a defect occurs that requires the battery pack to be opened, this involves destroying the connection between the electronics module and the battery module and, as a result, also the electronics module and the battery module.

### SUMMARY

Embodiments provide a battery pack, as well as a bicycle with such a battery pack, which enables simple and sustainable assembly and repair of the battery pack. Further embodiments provide a method, which enables simple assembly of the battery pack with as few components as possible.

A battery pack according to embodiments of the invention is used to supply power to a drive unit of a bicycle. The battery pack has a battery module with several battery cells. The battery cells are electrically connected to each other. The battery module has several battery cells, in particular between 20 and 35 battery cells, preferably 24 or 33 battery cells at 3.6 V. The battery cells are connected in particular in an 11s3p, 12s2p or 13s1p configuration. In an 11s3p configuration, 11 battery cells are connected in series in 3 parallel strings. In a 12s2p configuration, 12 battery cells are arranged in series in two parallel strings (12s2p). The battery cells in the 12s2p configuration are in particular arranged in two layers, each with two rows of battery cells, each with 4 batteries. The battery cells are cylindrical in shape, in particular. The battery module is in particular a battery module with a supply voltage in the low-voltage range. The nominal voltage of the battery module is in particular below 60 V and is preferably between 35 and 45 V and preferably 39.6 V or 43 V.

In addition to the battery module, the battery pack also comprises an electronics module. The electronics module comprises, in particular, a battery management system (BMS). The BMS serves in a known manner to monitor the battery cells, in particular with regard to their state of charge (cell voltage) and their temperature, to control the battery cells and to protect the battery cells. In particular, the electronics module also includes a connection plug via which the battery pack can be charged and discharged. The cell voltage of the interconnected battery cells is provided via the connection plug.

The electronics module comprises, in particular, at least one printed circuit board on which the BMS is formed and/or the connection plug is arranged. The electronics module may also comprise at least one further printed circuit board, in particular for forming a human-machine interface (HMI), in particular for displaying and reading out the state of charge of the battery pack.

The battery module and the electronics module are both compact units in particular. The battery module and the electronics module are detachably connected to each other. In this case, ‘detachably’ means that an electrical and/or mechanical connection between the battery module and the electronics module can be disconnected without damage and can also be re-established repeatedly. In particular, the battery module and the electronics module are connected to each other in a force-fitting and/or form-fitting manner and not in an integrally bonded manner.

The detachable connection, which is described in more detail below, allows the battery module and the electronics module to be separated from each other again without destroying the components, even after they have been connected. The individual components are not damaged and are reusable. Avoiding fixed (integrally bonded) connections and, in particular, cables also makes the manufacture of the battery pack much easier. Overall, this provides a sustainable battery pack that is easy to assemble and disassemble.

In particular, the battery module and the electronics module are connected by means of at least one plug-in connection. The plug-in connection can be established by moving the battery module and the electronics module relative to each other along a plug-in direction in order to either establish or release the connection. In particular, the electronics module has at least one first plug element and the battery module has at least one corresponding second plug element. The at least one first plug element and the at least one second plug element can be plugged into each other and form a form-fitting and/or force-fitting connection. In particular, the plug elements also serve to establish an electrical connection.

In one embodiment of the battery pack, different first plug elements and second plug elements are provided in particular for transmitting the cell voltage and for transmitting the status data (such as charge status or temperature) of the individual battery cells.

In a practical embodiment, the electronics module has at least one first plug element in the form of a clamping element which is connected in a clamping manner to a corresponding second plug element of the battery module. In particular, the electronics module has two clamping elements. In particular, the clamping elements protrude in the longitudinal direction of the battery pack relative to the rest of the electronics module and, in particular, relative to a printed circuit board of the electronics module, and are oriented in a plug-in direction. The at least one clamping element is designed in particular such that it is connected to the corresponding second plug element via a clamping force, in particular by means of a spring-elastic design.

The at least one clamping element has, in particular, a U-shaped main body. The U-shaped main body has two legs which are connected to each other via a base portion. A continuous slot is formed between the two legs. Electrical contacts are formed on the sides of the legs facing each other for contacting the corresponding second plug element. In particular, the legs are spring-elastic in order to generate a clamping force and/or the electrical contacts arranged on the inside are spring-elastic. The second plug element is fixed laterally in a form-fitting manner by the two legs.

The at least one clamping element serves in particular to transmit the cell voltage. In particular, a first clamping element serves to connect the electronics module to the negative terminals of the battery cells and a second clamping element serves to connect to the positive terminals of the battery cells.

In particular, the width of the slot is designed such that the corresponding second plug element is fixed therein in a force-fitting manner or by a clamping action. In particular, the slot width is in the range of 0.3-0.5 mm.

As already described above, the slot is continuous or uninterrupted, i.e. the slot has three open sides. This has several advantages: the corresponding second plug element can be moved over a relatively long length within the slot and can even be arranged so that it protrudes from the slot at the front end of the U-shaped main body, which allows for tolerance compensation. A further advantage is that the plug-in connection between the electronics module and the battery module can be established not only along one plug-in direction, but also along another plug-in direction transverse and, in particular, perpendicular to the first plug-in direction by inserting the second plug element into the clamping element along the slot. In particular, the first plug-in direction extends parallel to the longitudinal direction of the battery pack and the second plug-in direction extends parallel to the height direction of the battery pack.

In a further practical embodiment, the battery module has, as a second plug element, at least one plate-shaped intermediate element connected to a printed circuit board (busbar), which is clamped in the clamping element. In particular, the battery module has two intermediate elements, one of which is connected to the negative terminals of the battery cells and the other to the positive terminals of the battery cells. The intermediate element therefore transmits the cell voltage of the battery cells in particular. The plate-shaped intermediate element has a greater material thickness than the printed circuit board in particular. The intermediate element is more rigid than the printed circuit board and therefore less sensitive to forces during manufacture or when disconnecting the plug-in connection than the printed circuit board (busbar) itself.

The plate-shaped intermediate element can extend in particular in only one plane (in particular in an x-z plane), but it is also conceivable that the intermediate element is bent or has two parallel portions that are connected to each other so that the intermediate element also extends in the y direction. Overall, it is a flat element with a low material thickness compared to its longitudinal and transverse dimensions. The intermediate element is made of metal in particular.

Alternatively, it is also possible to connect the clamping element directly to the respective printed circuit board in a detachable manner and, in particular, to plug it onto the printed circuit board.

The at least one intermediate element is in particular connected in an integrally bonded manner, in particular welded, to a printed circuit board which directly contacts the battery cells. The at least one intermediate element has in particular a contact portion for this purpose. The contact portion has in particular a triangular geometry.

The at least one intermediate element has a plug-in portion which, in an assembled position, is at least partially received within the slot of the clamping element. The plug-in portion may be arranged to protrude on one or both sides of the continuous slot.

In another practical embodiment, the at least one intermediate element is fixed to the battery module in a form-fitting manner to prevent it from being pulled out against the plug-in direction (in particular parallel to the x-direction). In particular, the at least one intermediate element has a hook portion which, in an installed position, engages behind an undercut in the battery module. In particular, the undercut is formed by a cover of the battery cells and acts as a stop for the hook portion. This is intended to prevent, as far as possible, the connecting element from detaching from the battery module or the printed circuit board when the connection between the electronics module and the battery module is released against the plug-in direction.

In a further practical embodiment, the battery cells are connected to each other by a flexible printed circuit board and the flexible printed circuit board (flex PCB) is connected to the electronics module via a plug contact, in particular a flexible printed circuit (FPC) plug. The electronics module has a corresponding plug contact (or a corresponding socket) as the first plug element. The FPC plug represents a further second plug element. The flexible printed circuit board serves in particular to transmit the status data of the battery cells to the BMS and to control and balance the battery cells. This connection between the electronics module and the battery module can also be disconnected and restored without damage and does not require any cables.

In particular, the electronics module has a connection plug (or a connection socket) via which the battery cells are charged and/or discharged, wherein the connection plug is arranged in an integrally bonded manner on the electronics module. In particular, the connection plug is welded or soldered to a printed circuit board of the electronics module. Accordingly, a connection by means of a cable can be dispensed with.

Embodiments of the invention also relate to a bicycle (also known as an electric bicycle, e-bike or pedelec) with a drive unit, in particular an electric drive unit, and a battery pack as described above. The drive unit is connected to the battery pack for the supply of energy. The battery pack with the battery module and the electronics module is arranged in particular in a frame of the bicycle.

Embodiments of the invention also relate to a method for assembling a battery pack with an electronics module and a battery module, in particular a battery pack as described above. First, an electronics module with at least one first plug element is provided as a pre-assembly, and a battery module with several battery cells and at least one second plug element is provided as a further pre-assembly.

The electronics module and the battery module are then connected by establishing a plug-in connection through relative movement of the battery module and the electronics module along a plug-in direction, wherein at least one first plug element is clamped to a corresponding second plug element to establish a non-destructive, detachable connection.

The ability to connect the electronics module and the battery module to each other by means of simple plug-in connections makes the assembly of the battery module particularly easy.

As described above, a first plug element can be a clamping element with a continuous slot, which then allows assembly in a first plug-in direction and a second plug-in direction, parallel to the extent of the slot.

Assembly can be carried out in such a way that a first plug contact is first established between an FPC plug of a flexible printed circuit board and a corresponding plug contact, and then the relative movement takes place, to establish a clamping connection between two clamping elements and corresponding second plug elements.

For further details and advantages, reference is made to the above description.

### BRIEF DESCRIPTION OF THE DRAWINGS

Further practical embodiments and advantages are described in conjunction with the figures, in which:

FIG. 1 shows a battery pack with a battery module and an electronics module in a separated position in a perspective view obliquely from the rear;

FIG. 2 shows the battery pack from FIG. 1 in a connected position of the battery module and the electronics module;

FIG. 3 shows the battery pack from FIG. 2 in a detailed view;

FIG. 4 shows the battery pack from FIG. 1 with a battery module and an electronics module in a detached position in a perspective view obliquely from the front;

FIG. 5 shows the battery pack from FIG. 1 with a battery module and an electronics module in a position detached from one another in a top view;

FIG. 6 shows the battery pack from FIG. 5 with a battery module and an electronics module in a connected position in a top view;

FIG. 7 shows the battery module from FIG. 1 to 6 without intermediate elements in a perspective view obliquely from the front;

FIG. 8a shows a second intermediate element in a perspective view obliquely from the rear;

FIG. 8b shows the second intermediate element in a perspective view obliquely from the front;

FIG. 9a shows a first intermediate element in a perspective view obliquely from the rear;

FIG. 9b shows the first intermediate element in a perspective view obliquely from the front; and

FIG. 10 shows the electronics module without cover in a perspective view obliquely from the front.

### DETAILED DESCRIPTION OF ILLUSTRATIVE EMBODIMENTS

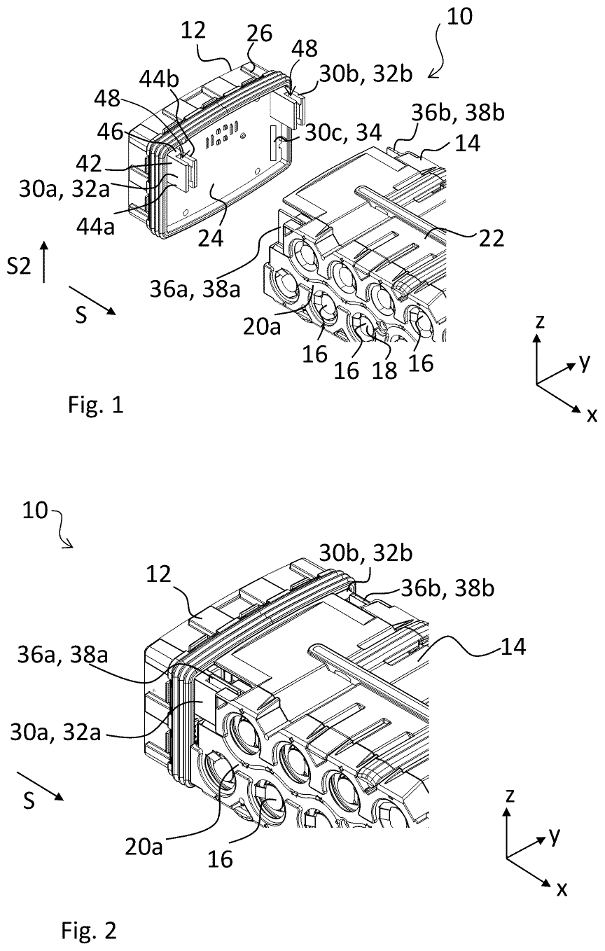

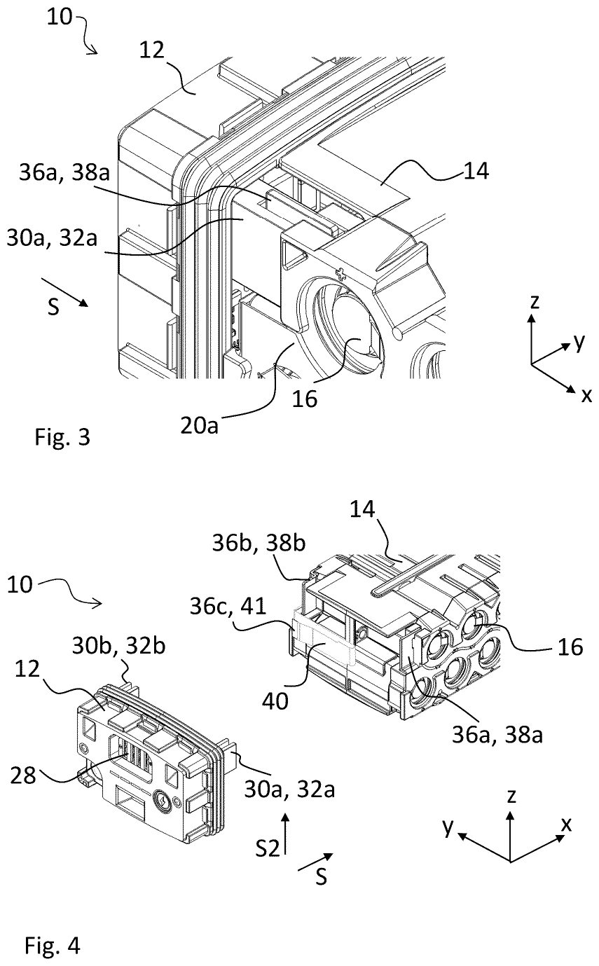

FIGS. 1 to 6 show a battery pack 10 with an electronics module 12 and a battery module 14. As can be clearly seen, the battery module 14 and the electronics module 12 are largely self-contained modules, each of which is available as an assembly and is only connected to the corresponding other module for assembly to form the battery pack 10.

The battery pack 10 extends in the longitudinal direction (x-direction), in the transverse direction (y-direction) and in the vertical direction (z-direction).

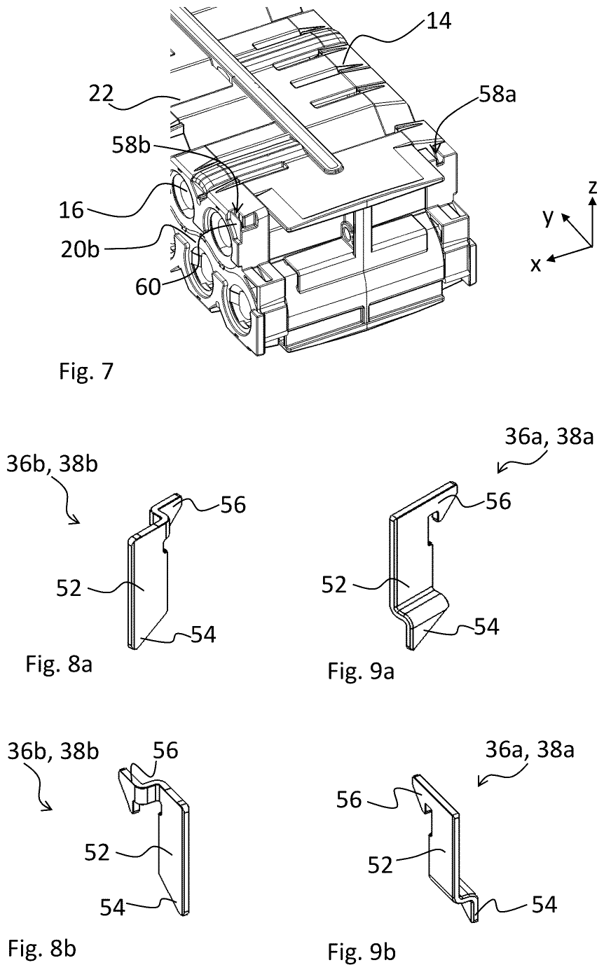

The battery module 14 comprises several cylindrical battery cells 16 (see FIG. 1, FIG. 4 and FIG. 7), which are arranged in two rows one above the other and each extend in the transverse direction (y-direction). The terminals 18 of the battery cells 16 are electrically connected via a first conductor plate (busbar) 20a on a first end face of the battery cells 16 (see FIG. 1 and FIG. 4) and a second conductor plate 20b (busbar) on the second end face of the battery cells 16 (see FIG. 7). The battery module 14 has a cover 22 which at least partially surrounds and holds together the battery cells 16.

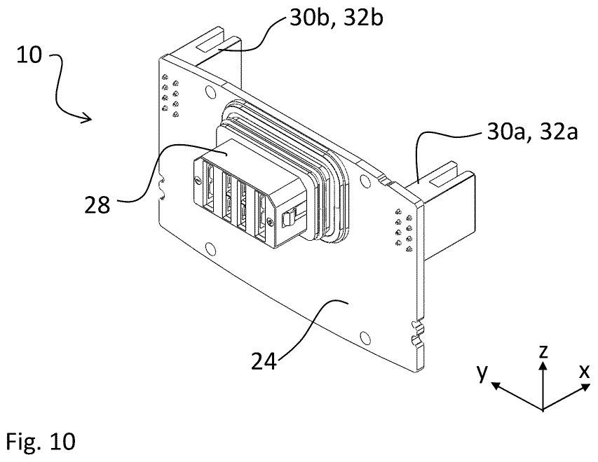

The electronics module 12 comprises a printed circuit board 24 (see FIG. 1) and, in this case, also a cover 26 and a seal 27. The electronics module 12 comprises a connection plug 28 (see FIG. 10) and a battery management system (BMS) (not shown).

The connection plug 28 is arranged on the printed circuit board 24 (see FIG. 10). The connection plug 28 is connected to the printed circuit board 24 in an integrally bonded manner, namely by welding. The connection plug 28 serves to transmit the cell voltage and to charge and discharge the battery cells 16.

To connect the electronics module 12 to the battery module 14, the electronics module 12 has three first plug elements 30a, 30b, 30c, namely two clamping elements 32a, 32b and a plug contact 34. The battery module 14 has three corresponding second plug elements 36a, 36b, 36c, namely two intermediate elements 38a, 38b and a flexible printed circuit board 40 with an end-side flexible printed circuit (FPC) plug 41.

The cell voltage for charging and discharging the battery cells 16 is transmitted via the clamping elements 32a, 32b and the intermediate elements 38a, 38b and connected to the connection plug 28. The status data of the battery cells 16 is transmitted to the BMS via the flexible printed circuit board 40, the FPC plug 41 and the plug contact 34.

The clamping elements 32a, 32b can be clearly seen in FIG. 1 and FIG. 4 to 6. The clamping elements 32a, 32b are each arranged at the edge of the printed circuit board 24 and protrude in the longitudinal direction (x-direction) of the battery pack 10 relative to the printed circuit board 24.

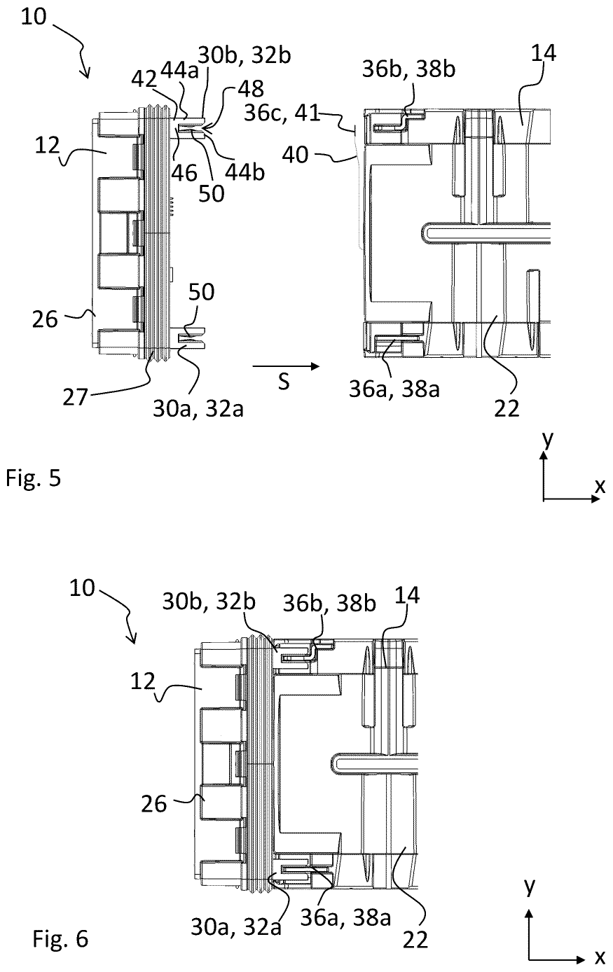

The clamping elements 32a, 32b each have a U-shaped main body 42 with a first leg 44a and a second leg 44b. The two legs 44a, 44b are connected to each other by a base portion 46. A slot 48 extending in the vertical direction (z-direction) is formed between the legs 44a, 44b. As can be seen in FIG. 5, electrical contacts 50 are formed on the facing surfaces of the legs 44a, 44b. The legs 44a, 44b are designed to be spring-loaded outwards in order to clamp the corresponding intermediate elements 38a, 38b in the slot 48, and the contacts 50 are designed to be spring elastic.

As already described above, plate-shaped intermediate elements 38a, 38b are arranged on the battery module 14 corresponding to the clamping elements 32a, 32b. The clamping elements 32a, 32b are not directly connected to the printed circuit board 20a, 20b for transmitting the voltage.

The intermediate elements 38a, 38b are shown individually in FIGS. 8a, 8b, 9a and 9b. The intermediate elements 38a, 38b are designed differently here, which is due to the structure of the battery module 14. However, the intermediate elements 38a, 38b function in the same way.

The intermediate elements 38a, 38b are substantially plate-shaped and extend in the x-z plane in the installation position.

The intermediate elements 38a, 38b each have a plug-in portion 52, which extends in the vertical direction (z-direction) and is accommodated in an installation position within the slot 48 of the respective clamping element 32a, 32b. The plug-in portion 52 extends over a greater height than the slot 48 or the main body 42 of the clamping element 32a, 32b, so that the plug-in portion 52 protrudes partially from the slot 48 at the top and/or bottom in an installed position (see FIG. 2).

The intermediate elements 38a, 38b also have a contact portion 54 at which the intermediate elements 38a, 38b can be connected to the respective printed circuit board 20a, 20b in an integrally bonded manner or are connected in the installation position. The contact portion 54 extends here at the lower end of the respective intermediate element 38a, 38b. The contact portion 54 is triangular in shape. In the first intermediate element 38a, the contact portion 54 is arranged via a curved shoulder in the y-direction offset from the plug-in portion 52. However, the contact portion 54 of the first intermediate element 38a extends parallel to the plug-in portion 52.

Furthermore, the intermediate elements 38a, 38b have a hook portion 56, which serves to form a form-fitting connection with the battery module 14. This becomes particularly clear in conjunction with FIG. 7. It can be seen that the hook portion 56 engages behind the cover 22 of the battery module 14 in each case at an undercut 58a, 58b. This serves to fix the intermediate element 38a, 38b in a form-fitting manner when the connection between the electronics module 12 and the battery module 14 is released against a plug-in direction S. In the second intermediate element 38b, the hook portion 56 is spaced apart from the plug-in portion 52 by a curved shoulder in the y-direction and extends parallel to the plug-in portion 52 in an x-z plane.

In order to additionally fix the intermediate element 38b in the transverse direction of the battery pack 10, a further plate 60 is also arranged adjacent to the hook portion 56 in the undercut 58a, 58b.

FIGS. 1 to 6 show the intermediate elements 38a, 38b in an installation position in the battery module 14. The intermediate elements 38a, 38b are each inserted with their hook portion 56 into the undercuts 58 and are connected with the contact portion 54 to the respective printed circuit board 20a, 20b (not visible). The plug-in portion 52 protrudes longitudinally beyond the surrounding part of the battery module 14 to establish the connection.

In addition, the battery module 14 also has a second plug element 36c, namely the flexible printed circuit board 40 (see FIGS. 4 and 5) with an FPC plug 41 arranged at the end. Correspondingly, the electronics module 12 has the plug contact 34. The flexible printed circuit board 40 is bent at an end portion and guided in two parallel portions in order to compensate for relative movement between the battery module 14 and the electronics module 12.

The following describes how the connection between the electronics module 12 and the battery module 14 is established. To establish a non-destructive, detachable connection, the battery module 14 and the electronics module 12 are moved towards each other in a plug-in direction S. The plug-in direction S is aligned parallel to the longitudinal direction (x-direction) of the battery pack 10.

The plug 41 of the flexible printed circuit board 40, which is located at the end, is connected to or plugged into the plug contact 34 of the electronics module 12. This connects the battery cells 16 to the BMS for the transmission of status data.

The respective plug-in portion 52 of the intermediate elements 38a, 38b is clamped into the slot 48 of the corresponding clamping elements 32a, 32b, and the clamping force creates a force-fitting and conductive connection. The clamping elements 32a, 32b also cause a form fit in the transverse direction (y-direction) of the battery pack 10. In the vertical direction (z-direction), relative movement of the battery module 14 with respect to the electronics module 12 is possible, since the intermediate elements 38a, 38b have a certain amount of play in the slot 48 in the vertical direction and in the opposite direction.

In addition to the connection in the plug-in direction S parallel to the longitudinal direction, it is also possible to mount the battery module 14 and the electronics module 12 in a second plug-in direction S2 parallel to the vertical direction (z-direction) and to the direction of extent of the slot 48. In this case, the electronics module 12 can be plugged onto the battery module 14 in the opposite direction to the vertical direction, so that the plug-in portions 52 slide into the respective slot 48 from below.

To release the connection, the electronics module 12 and the battery module 14 are moved apart in the opposite direction to the plug-in direction S or the second plug-in direction S2. The plug-in portion 52 of the intermediate elements 38a, 38b, which is only held in place by clamping, can be easily removed from the slot 48 after overcoming the clamping force and released from the clamping element 32a, 32b. The flexible printed circuit board 40 can then be unplugged from the plug contact 34.

Overall, this creates a plug-in connection between the electronics module 12 and the battery module 14, which is easy to establish and can be disconnected without damage. No cables are provided to connect the individual components in the battery pack 10.

What is claimed is:

1. A battery pack comprising:
a battery module comprising a plurality of battery cells, which are electrically connected to one another; and
an electronics module,
wherein the electronics module and the battery module are detachably connected to each other.

2. The battery pack according to claim 1,
wherein
the battery module and the electronics module are connectable to each other by a plug-in connection.

3. The battery pack according to claim 1,
wherein
the electronics module comprises at least one first plug element in form of a clamping element, which is connectable in a clamping manner to a corresponding second plug element of the battery module.

4. The battery pack according to claim 3,
wherein
the clamping element has a U-shaped main body.

5. The battery pack according to claim 3,
wherein
the clamping element has a continuous slot.

6. The battery pack according to claim 1,
wherein
the battery module comprises, as a second plug element, at least one plate-shaped intermediate element, which is connected to a printed circuit board and which is clampable in a corresponding clamping element.

7. The battery pack according to claim 6,
wherein
the intermediate element is fixed in a form-fitting manner to the battery module to prevent the intermediate element from being pulled out against a plug-in direction.

8. The battery pack according to claim 1,
wherein the battery module has a flexible printed circuit (FPC) plug as a second plug element, which is able to connect a flexible printed circuit board connected to the battery cells to the electronics module with a first plug element in form of a plug contact.

9. The battery pack according to claim 1,
wherein
the electronics module comprises a connection plug via which the battery cells are chargeable and/or dischargeable, and
wherein the connection plug is arranged in an integrally bonded manner on the electronics module.

10. A bicycle comprising:
a drive unit; and
the battery pack according to claim 1.

11. A method for assembling a battery pack, the method comprising:
providing an electronics module comprising at least one first plug element;
providing a battery module comprising a plurality of battery cells and at least one second plug element; and
establishing a plug-in connection between the electronics module and the battery module by relative movement along a plug-in direction, wherein the at least one first plug element is connected in a clamping manner to a corresponding second plug element.
